(19) United States
(12) Patent Application Publication
(10) Pub. No.: US 2025/0230040 A1
(43) Pub. Date: Jul. 17, 2025

(54) METHOD AND REACTOR SYSTEM FOR SPLITTING WATER AND/OR CARBON DIOXIDE

(71) Applicant: The Regents of the University of Colorado, a body corporate, Denver, CO (US)

(72) Inventors: Kent WARREN, Broomfield, CO (US); Justin TRAN, Broomfield, CO (US); Alan W. WEIMER, Niwot, CO (US)

(21) Appl. No.: 18/703,245

(22) PCT Filed: Oct. 19, 2022
(86) PCT No.: PCT/US2022/047153

§ 371 Date: Apr. 19, 2024

Related U.S. Application Data
(60) Provisional application No. 63/270,030, filed on Oct. 20, 2021.

(51) Int. Cl. C01B 3/06; B01J 8/00; B01J 8/02; C01B 32/40

(52) U.S. Cl. CPC C01B 3/063; B01J 8/001; B01J 8/0278; C01B 32/40; B01J 2208/00017; B01J 2208/00539

(57) ABSTRACT

Methods and systems for splitting one or more of water and carbon dioxide are disclosed. Exemplary methods can operate under substantially isothermal conditions. The methods can include use of a material including two or more spinel phases in a solid solution. The solid solution can include oxygen, aluminum, and one or more transition metals.

### CROSS REFERENCE TO RELATED APPLICATION

This application claims the benefit of U.S. Provisional Application Ser. No. 63/270,030, filed on Oct. 20, 2021, and entitled METHOD AND REACTOR SYSTEM FOR SPLITTING WATER AND/OR CARBON DIOXIDE, the contents of which are hereby incorporated herein by reference to the extent such contents do not conflict with the present disclosure.

### FIELD OF INVENTION

The present disclosure generally relates to methods and systems for splitting one or more of water and carbon dioxide.

### BACKGROUND OF THE DISCLOSURE

The use of hydrogen as a renewable fuel has been stymied by an inability to produce hydrogen cleanly and economically. Conventional solar thermochemical approaches consider a two-step redox cycle with benchmark ceria or a perovskite in a temperature swing configuration, where reduction occurs at a temperature much higher than oxidation. Isothermal redox cycling is thought to be feasible and avoids the solid-solid heat recuperation and material stability challenges associated with large temperature swing; yet, it has long been thought to be inefficient due to the thermodynamic unfavourability of operating the exothermic oxidation reaction at higher temperatures. Accordingly, improved methods and systems suitable for splitting water (and/or carbon dioxide) in relatively efficient manner at relatively isothermal conditions are desirable.

Any discussion, including discussion of problems and solutions, set forth in this section has been included in this disclosure solely for the purpose of providing a context for the present disclosure. Such discussion should not be taken as an admission that any or all of the information was known at the time the invention was made or otherwise constitutes prior art.

### SUMMARY OF THE DISCLOSURE

Various embodiments of the present disclosure relate to methods suitable for splitting water and/or carbon dioxide. While the ways in which various embodiments of the present disclosure address drawbacks of prior methods and systems are discussed in more detail below, in general, embodiments of the disclosure provide improved methods and reactor systems for splitting water and/or carbon dioxide under isothermal or nearly isothermal conditions in a relatively efficient manner.

In accordance with exemplary embodiments of the disclosure, a method of splitting one or more of water and carbon dioxide is provided. An exemplary method includes the steps of providing a first material within a first reactor of a reactor system, the first material comprising two or more spinel phases in a solid solution, the solid solution comprising oxygen, aluminum, and one or more transition metals and providing one or more of H₂O and CO₂ to the first reactor. A temperature within the reactor can be greater than 800° C. A partial pressure of oxygen within the reactor can be greater than 10⁻⁷ bar. In accordance with examples of these embodiments, the method can further include providing a second material within a second reactor of the reactor system, the second material comprising the same chemical formula as the first material, and providing N₂ and/or another inert gas to the second reactor. A temperature within the second reactor can be greater than 800° C. A partial pressure of oxygen within the second reactor can be greater than 10⁻⁷ bar. In accordance with various aspects of these embodiments, the temperature within the first reactor and the temperature within the second reactor is between 800° C. and 1500° C. Additionally or alternatively, one or more of the partial pressure of oxygen within the first reactor and the partial pressure of oxygen within the second reactor is between 10⁻⁷ bar and 10⁻¹ bar. In accordance with various examples, the first material and the second material each comprise (M_{ζ}Al_{1-ζ})_{3-δ}O₄, where ζ is greater than ⅓, and wherein M is one or more transition metals. ζ can be less than 1. The exemplary first and second materials described herein can exhibit large changes in oxygen content within the range of oxygen partial pressures expected in large-scale systems. When operated nearly isothermally at, for example, 1400° C., the (e.g., iron aluminate-based) materials described herein demonstrate a capacity for hydrogen production greater than 500 μmol g⁻¹ of material and, as a result, remain viable even under high conversion conditions (i.e., molar H₂O/H₂<500:1), exceeding the hydrogen yields of three oxygen vacancy-mediated candidates following a 400° C. (or less) temperature swing. Isothermal water and/or carbon dioxide splitting using (e.g., iron) aluminate-based materials opens the door for more simple, robust, and efficient production of renewable hydrogen. Additional examples of a method in accordance with the disclosure are set forth below.

In accordance with additional examples of the disclosure, a reactor system is provided. An exemplary reactor system includes a first reactor; a first material within the first reactor, the first material comprising two or more spinel phases in a solid solution, the solid solution comprising oxygen, aluminum, and one or more transition metals; one or more of a H₂O source and a CO₂ source fluidly coupled to the first reactor; and a controller configured to: control a temperature within the first reactor to greater than 800° C. and to control a partial pressure of oxygen within the first reactor to greater than 10⁻⁷ bar. Exemplary systems, and particularly the controller, can be further configured to perform a method as described herein.

These and other embodiments will become readily apparent to those skilled in the art from the following detailed description of certain embodiments having reference to the attached figures; the invention not necessarily being limited to any particular embodiment(s) disclosed.

### BRIEF DESCRIPTION OF THE DRAWING FIGURES

A more complete understanding of exemplary embodiments of the present disclosure can be derived by referring to the detailed description and claims when considered in connection with the following illustrative figures.

FIG. 1 illustrates a reduction and oxidation cycle using material described herein.

FIGS. 2 and 3 illustrate exemplary methods and systems in accordance with examples of the disclosure.

FIG. 4 illustrates observed (Y_{obs}) and calculated (Y_{calc}) diffraction patterns of (A) Fe33Al67, (B) Fe47Al53, and (C) Co13Fe20Al67 following synthesis and the experimental campaign. The characteristic diffraction peaks assigned to FeAl₂O₄ and Fe₃O₄ are indicated by solid and dashed vertical lines, while the diffraction peaks assigned to corundum, hematite, and other spinel phases are referred to using triangle (▴), asterisk (*), and circle (●) symbols, respectively.

FIG. 5 illustrates stability of the (A) Fe—Al—O and (B) Co—Fe—Al—O systems as a function of temperature and oxygen partial pressure at select cation compositions. Circle symbols (●) indicate equilibrium oxygen partial pressures that are attainable under water-splitting conditions, as determined according to Equation 6 (i.e., n_{i,H}_{₂}=0), and ζ is defined as (mol_{Fe})(mol_{Fe}+mol_{Al})⁻¹ and (mol_{Co})(mol_{Co}+mol_{Fe})⁻¹ for the Fe—Al—O and Co—Fe—Al—O systems, where for the latter the aluminum content is 0.67 mol_{Al} mol_{c}⁻¹.

FIG. 6 illustrates representative thermogravimetric experiments for establishing the equilibrium behavior of iron aluminate-based materials. Percent relative change in mass from the fully oxidized state and reference temperature (top line) as a function of time at a particular oxygen partial pressure: (A) pO₂≈4.65×10⁻², 5.40×10⁻³ bar and (B) pO₂≈9.39×10⁻⁴±1.08×10⁻⁴ bar.

FIG. 7 illustrates summation of the thermogravimetric measurements. Percent relative change in mass between the fully oxidized and equilibrium states (symbols) of (A) Co13Fe20Al67, (B) Fe33Al67, and (C) Fe47Al53 as a function of oxygen partial pressure for temperatures between 1000° C. and 1400° C. Lines indicate defect model predictions.

FIG. 8 illustrates equilibrium cation nonstoichiometry measurements of iron aluminate spinel solid solutions (ζ<1) and magnetite (ζ=1) as a function of oxygen partial pressure at 1400° C. Open symbols refer to this work, whereas closed symbols refer to data extracted from elsewhere. Lines indicate defect model predictions.

FIG. 9 (A) Representative van't Hoff plots, evaluated at select cation nonstoichiometries, for the endothermic reduction of the Fe33Al67 spinel solid solution. (B) Standard partial molar properties (i.e., enthalpy and entropy) for the reduction of several candidate redox materials, namely ceria, LSMA6464, CTM55, and the iron aluminates; solid and dot-dashed lines correspond to the left and right ordinate, respectively.

FIG. 10 illustrates a comparison of the percent relative change in mass, as a function of oxygen partial pressure at 1400° C., between the fully oxidized and equilibrium states (symbols) of several candidate redox materials, namely ceria, LSMA6464, CTM55, and the iron aluminate-based materials. Solid and dashed lines indicate thermodynamic predictions and linear approximations, respectively, while the vertical dot-dashed line represents the oxygen partial pressure defined by the equilibrium of water thermolysis at 1 bar (see Equation 6).

FIG. 11 illustrates thermochemical water-splitting performance of several candidate redox materials under isothermal conditions, where the oxidation step is evaluated with (A) pure steam (i.e., H₂O/H₂=∞) and (B) steam diluted with product hydrogen (i.e., H₂O/H₂<<∞). For each calculation, the reduction step is assumed to occur under an inert atmosphere with 10 ppm residual oxygen. Solid and dashed lines indicate thermodynamic predictions and linear approximations, respectively.

FIG. 12 illustrates thermochemical water-splitting performance of several candidate redox materials as a function of temperature swing, where the oxidation step is evaluated under high (i.e., H₂O/H₂=500:1) and low (i.e., H₂O/H₂=1500:1) conversion conditions as denoted by the solid and dashed lines, respectively. For each calculation, the reduction step is assumed to occur at 1400° C. under an inert atmosphere with 10 ppm residual oxygen.

It will be appreciated that elements in the figures are illustrated for simplicity and clarity and have not necessarily been drawn to scale. For example, the dimensions of some of the elements in the figures may be exaggerated relative to other elements to help improve understanding of illustrated embodiments of the present disclosure.

### DETAILED DESCRIPTION OF EXEMPLARY EMBODIMENTS

Although certain embodiments and examples are disclosed below, it will be understood by those in the art that the invention extends beyond the specifically disclosed embodiments and/or uses of the invention and obvious modifications and equivalents thereof. Thus, it is intended that the scope of the invention disclosed should not be limited by the particular disclosed embodiments described below.

In this disclosure, “gas” may include material that is a gas at normal temperature and pressure, a vaporized solid and/or a vaporized liquid, and may be constituted by a single gas or a mixture of gases, depending on the context. An inert gas can be a gas that does not take part in a chemical reaction to an appreciable extent. An exemplary inert gas includes nitrogen.

In this disclosure, continuously or continuous or continually can refer to without interruption as a timeline, without any material intervening step, without changing process conditions, or immediately thereafter, as a next step, depending on the context.

In this disclosure, any two numbers of a variable can constitute a workable range of the variable, and any ranges indicated can include or exclude the endpoints. Additionally, any values of variables indicated (regardless of whether they are indicated with “about” or not) may refer to precise values or approximate values and include equivalents, and may refer to average, median, representative, majority, etc. in some embodiments. Further, in this disclosure, the terms “including,” “constituted by” and “having” and variations thereof can refer independently to “typically or broadly comprising,” “comprising,” “consisting essentially of,” or “consisting of” and variations thereof in some embodiments. In accordance with aspects of the disclosure, any defined meanings of terms do not necessarily exclude ordinary and customary meanings of the terms.

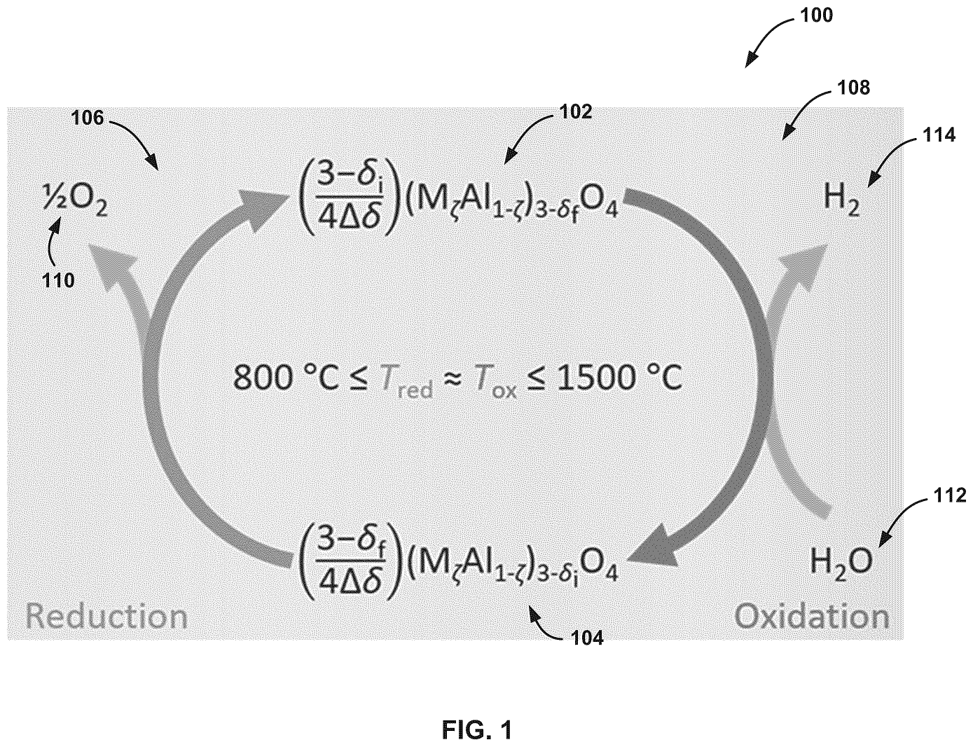

Turning now to the figures, FIG. 1 illustrates a reduction and oxidation cycle 100 using material 102, 104 described herein. Material 102, 104 can be or include two or more spinel phases in a solid solution, the solid solution comprising oxygen, aluminum, and one or more transition metals. Exemplary material includes material represented by the formula: (M_{ζ}Al_{1-ζ})_{3-δ}O₄, where ζ is greater than ⅓, and wherein M is one or more transition metals. For example, ζ can be greater than ⅓ and less than 1. M can be selected from, for example, one or more of Fe, Co, Ti, Mn, Mg, Zn, Ni, and Cr. As set forth in more detail below, the material can include cation defects (δ), which enable the removal of oxygen and splitting of the one or more of the water and the carbon dioxide.

During a reduction phase 106 of reduction and oxidation cycle 100, material 104 is reduced and oxygen 110 is evolved. During an oxidation phase 108 of reduction and oxidation cycle 100, water or carbon dioxide—e.g., from a source 112 can be added to material 102 and hydrogen 114 can be evolved.

A temperature during reduction and oxidation cycle 100 can be substantially isothermal. In this context, substantially isothermal can mean that a temperature during reduction phase 106 and a temperature during oxidation phase 108 of reduction and oxidation cycle 100 are within ±10 or ±25 or ±50° C. of each other during operation. In accordance with examples of the disclosure, the temperature during reduction phase 106 and/or during oxidation phase 108 is between 800° C. and 1500° C.

A partial pressure of oxygen during reduction and oxidation cycle 100 can be greater than 10⁻⁷ bar. For example, the partial pressure of oxygen during reduction phase 106 can be greater than 10⁻⁷ bar or between 10⁻⁷ bar and 10⁻¹ bar. Additionally or alternatively, the partial pressure of oxygen during oxidation phase 108 can be greater than 10⁻⁷ bar or between 10⁻⁷ bar and 10⁻¹ bar.

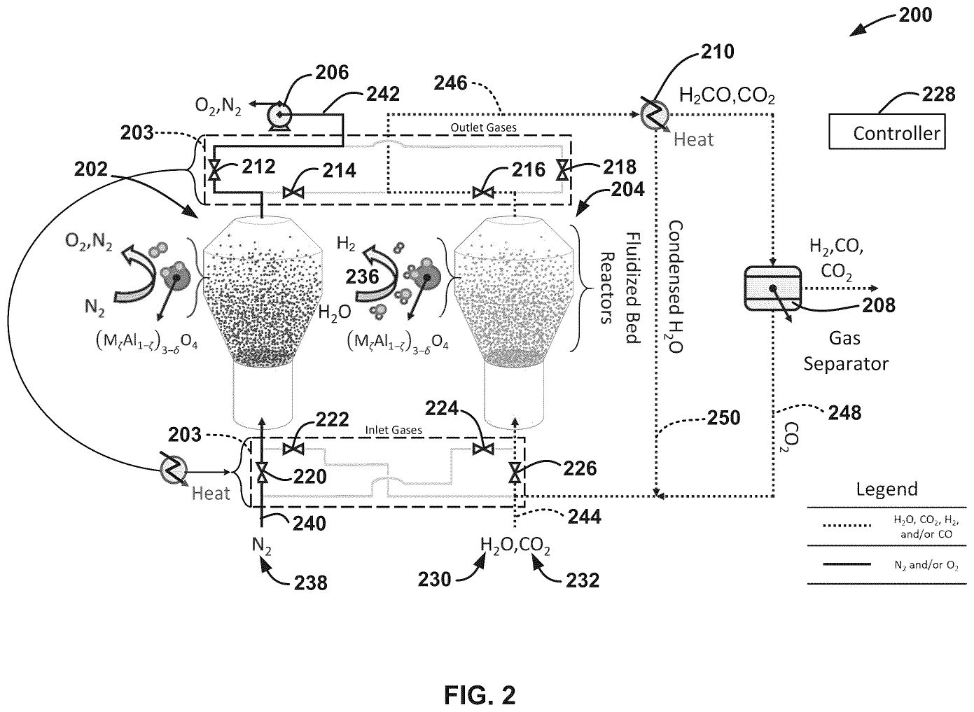

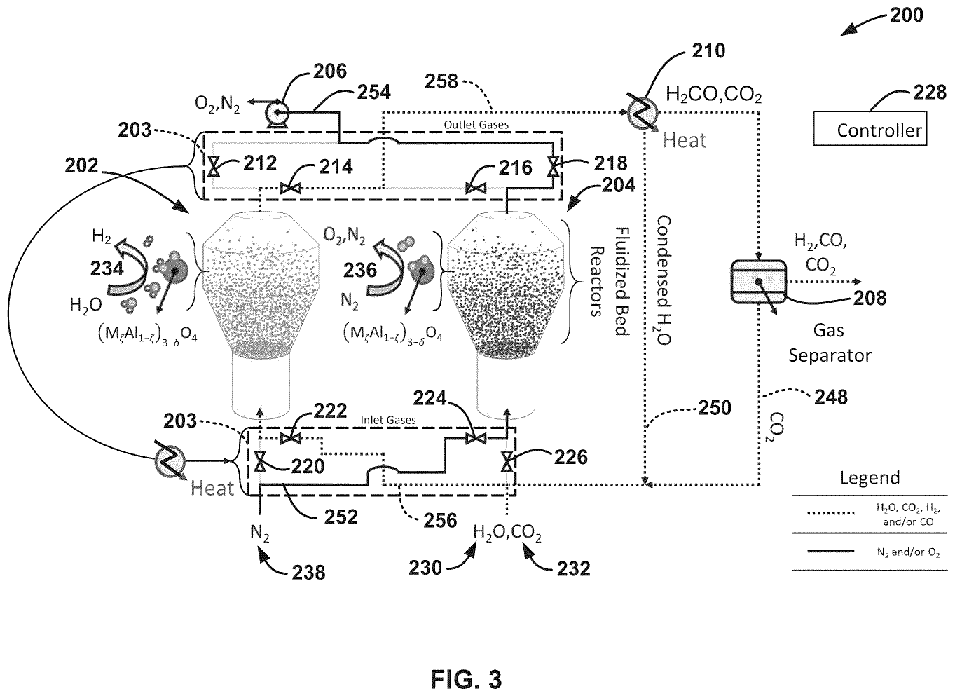

Turning now to FIGS. 2 and 3, a reactor system 200, including a first reactor 202 and a second reactor 204, is illustrated. Reactor system 200 can also include other components, such a heat exchanger 203, a compressor 206, a gas separator 208, a condenser 210, valves 212-226, a controller 228, one or more of a H₂O source and a CO₂ source 230, 232 fluidly coupled to at least one or more of first reactor 202 and second reactor 204, a nitrogen source 238, and lines 240-258.

First reactor 202 and second reactor 204 can each be or include a fluidized bed reactor with the fluidized material comprising material as described herein. Material in the first reactor can be referred to as first material and material in the second reactor can be referred to as second material. The first and second materials can be represented by the same chemical formula. Further, first and second can be used to refer to different reactors. The first and second reactor can be interchangeable.

Heat exchanger 203 can be any suitable heater exchanger. In accordance with examples of the disclosure, heat exchanger 203 is configured to use heat from gas exhausted from reactor 202 and/or reactor 204 (e.g., from lines 242, 246, 254, 258) to heat gas from one or more sources 230, 232, and 238. The gas exhausted from reactor 202 and/or reactor 204 can be at or near the operating temperature of the respective reactor. The sources can be at, for example, ambient temperature.

Compressor 206 can be or include any suitable compressor.

Gas separator 208 can be any suitable separator that can separate H₂ and/or CO, from a mixture of, for example, H₂, CO, and/or CO₂. By way of example, gas separator 208 can be or include a pressure swing adsorption or membrane separation unit.

Condenser 210 can be or include any suitable heat exchanger or the like to reduce a gas temperature to a temperature at or below which water condenses. By way of example, condenser 210 can be or include twin-tower desiccant dryers.

Valves 212-226 can be or include any suitable valve, such as pneumatic valves.

Controller 228 can include electronic circuitry and software to selectively operate valves (e.g., valves 212-226), manifolds, heaters, pumps (e.g., compressor 206) and other components included in system 200. Such circuitry and components can operate to introduce reactants (e.g., from source 230 and/or 232) or other gases from the respective sources. Controller 228 can control timing of gas pulse sequences, temperature within the reactor(s), pressure within the reactor(s), partial pressure of gases, and various other operations to provide proper operation of the system. The controller can include control software to electrically or pneumatically control valves to control flow of gases into and/or out of the reactor. The controller can include modules, such as a software or hardware component, e.g., a FPGA or ASIC, which perform certain tasks. A module can advantageously be configured to reside on the addressable storage medium of the control system and be configured to execute one or more processes.

In FIG. 2, first reactor 202 is operated in a reduction phase or mode as described above and second reactor 204 is operated in an oxidation phase or mode. In the illustrated example, nitrogen from nitrogen source 238 is fed to first reactor 202 via line 240 and valve 220 and material 234 is reduced within first reactor 202 and oxygen is generated. The oxygen can be mixed with the nitrogen previously provided. The oxygen can be sent to compressor 206 via line 242 and valve 212 and compressed using compressor 206 and stored, if desired.

One or more of water and carbon dioxide from sources 230, 232 can be provided to second reactor, operating in oxidation mode, to produce H₂, CO, H₂O, and/or CO₂, via line 244 and valve 226. First reactor 202 and second reactor 204 can be operating at the same time—e.g., for an overlapping time period. The H₂, CO, H₂O, and/or CO₂ can be sent via line 246 and valve 216 to condenser 210 to remove heat as described herein. Product gasses (e.g., H₂, CO) can be separated using gas separator 208 and stored, if desired. As illustrated, CO₂ from gas separator 208 can be recirculated to second reactor 204 via line 248 and valve 226. Additionally or alternatively, H₂O from condenser 210 can be recirculated back to second reactor 204 via line 250 and valve 226.

With reference to FIG. 3, an operation of first reactor 202 and second reactor 204 can be switched, such that first reactor 202 operates in oxidation mode and second reactor operates in reduction mode. This can allow continuous operation of reactor system 200, while extracting product gases. Switching can be controlled by controller 228 and can occur when the change in the extent of reaction (Δδ) between reduction and oxidation steps is substantially equal (see FIG. 1). In this context, substantially equal can mean that the extent of reaction after reduction phase 106 and the extent of reaction after oxidation phase 108 of reduction and oxidation cycle 100 are within ±1 or ±2 or ±5% of each other.

In the case illustrated in FIG. 3, nitrogen can be fed to second reactor 204 via line 252 and valve 224 and material 236 is reduced within second reactor 204 and oxygen is generated. The oxygen can be mixed with the nitrogen previously provided. The oxygen can be sent to compressor 206 via line 254 and valve 218 and compressed using compressor 206 and stored, if desired.

One or more of water and carbon dioxide from sources 230, 232 is provided to first reactor 202 via line 256 and valve 222, wherein the first reactor is operating in oxidation mode, to produce H₂, CO, and/or CO₂. Product gasses (e.g., H₂, CO) can transmitted vial line 258 and valve 214 to be separated using condenser 210 and gas separator 208 and stored, if desired. As illustrated, CO₂ from gas separator 208 can be recirculated to first reactor 202 via line 248, 256 and valve 222. Additionally or alternatively, H₂O from condenser 210 can be recirculated back to first reactor 202 via line 250, 256 and valve 222.

During operation, controller 228 can independently control a temperature within first reactor 202 and second reactor 204 to temperatures noted herein—e.g., to temperatures greater than 800° C. or between 800° C. and 1500° C. Further, controller can control temperature of first reactor 202 and second reactor 204, to substantially isothermal temperatures (within about ±10 or ±25 or ±50° C.). In addition, controller 228 can control a partial pressure of oxygen within first reactor 202 and second reactor 204—e.g., to greater than 10⁻⁷ bar or 10⁻⁷ bar and 10⁻¹ bar. In some cases, the partial pressure of oxygen in the first reactor is controlled to be greater than the partial pressure of oxygen in the second reactor. In some cases, the partial pressure of oxygen in the second reactor is controlled to be greater than the partial pressure of oxygen in the first reactor.

In accordance with further examples of the disclosure, a method of splitting one or more of water and carbon dioxide—e.g., using reactor system 200—includes providing a first material within a first reactor of a reactor system; and providing one or more of H₂O and CO₂ to the reactor, wherein a temperature within the first reactor is greater than 800° C., and wherein a partial pressure of oxygen within the first reactor is greater than 10⁻⁷ bar. The first material can be a material as described herein—e.g., material comprising two or more spinel phases in a solid solution, the solid solution comprising oxygen, aluminum, and one or more transition metals. The method can further include providing a second material within a second reactor of the reactor system, the second material comprising the same chemical formula as the first material; and providing N₂ to the second reactor, wherein a temperature within the second reactor is greater than 800° C., and wherein a partial pressure of oxygen within the second reactor is greater than 10⁻⁷ bar. The first and second materials, partial pressures, and temperatures can be as noted above. Exemplary methods can further include switching operation of the first and second reactors from oxidation to reduction modes during operation to allow for continuous or substantially continuous operation of a reactor system including two or more reactors. In such cases, the method can include a two-step reduction-oxidation process. Methods and systems as described herein can have demonstrated a capacity for hydrogen production greater than 500 μmol g⁻¹ or material per cycle and, as a result, remain viable even under high conversion conditions (i.e., molar H₂O/H₂<500:1), exceeding the hydrogen yields of three oxygen vacancy-mediated candidates following a 400° C. (or less) temperature swing. Isothermal water splitting using (e.g., iron) aluminate-based materials opens the door for more simple, robust, and efficient production of renewable hydrogen. For example, in the case of splitting water, exemplary methods are capable of producing hydrogen in atmospheres that contain existing hydrogen, such that the partial pressure of oxygen within the second reactor is greater than that described by a 7:1 or 200:1 H₂O:H₂ ratio. In the case of splitting CO₂, exemplary methods are capable of producing carbon monoxide in atmospheres that contain existing carbon monoxide, such that the partial pressure of oxygen within the second reactor is greater than that described by a 2:1 or 64:1 CO₂:CO ratio.

Specific examples are provided below. The example embodiments of the disclosure do not limit the scope of the invention, since these embodiments are merely examples of the embodiments of the invention. Any equivalent embodiments are intended to be within the scope of this invention. Indeed, various modifications of the disclosure, in addition to those shown and described herein, such as alternative useful combinations of the elements described, may become apparent to those skilled in the art from the description. Such modifications and embodiments are also intended to fall within the scope of the appended claims.

Examples of the disclosure can be used to convert intermittent solar radiation into storable and transportable chemical fuels that can enable access to sustainable feedstocks and dispatchable sources of power, regardless of geographic location. Heat can be obtained via concentrating optics and/or renewable sources of electricity (e.g., photovoltaics). If coupled with established catalytic processes like Fischer-Tropsch synthesis, product H₂ and CO can be converted to various liquid hydrocarbons (e.g., diesel) and organic oxygenates (e.g., methanol) that are free of nitrogen- and sulfur-containing impurities. For industries that rely on chemical fuels produced through conventional means (i.e., coal gasification, methane reforming, etc.), solar-driven gas-to-liquid technologies offer a viable alternative that can reduce dependence on diminishing fossil energy resources and thus mitigate associated greenhouse gas emissions.

By initiating oxidation at higher temperatures, such as those described above, reaction kinetics are improved, and if redox regimes are operated substantially isothermally mechanical stresses induced by thermal cycling and challenges associated with implementing solid phase heat recovery can be avoided. Although the requirement for sensible heating of process gases increases, the integration of highly effective gas phase heat recovery can mitigate this otherwise dominant source of irreversibility. Substantially isothermal redox cycling, while it offers several practical advantages, lowers the cyclic capacity of an oxide for the production of H₂ (and/or CO), which in this case can be dictated by the difference in oxygen chemical potential between the inert sweep gas and high-temperature oxidant. As a result, unlike redox schemes that abide by a temperature swing, material selection is not strictly limited to those that exhibit large enthalpic and entropic changes; rather, materials that preferentially exhibit greater extents of reaction within the attainable range of oxygen chemical potential are more desirable.

Ultimately, the results demonstrate that (e.g., iron) aluminate-based materials exhibit superior performance and remain viable under (less favorable) conditions expected in large-scale systems, where delivering excess oxidant and implementing wide temperature swings are avoided to improve efficiency.

### Materials Synthesis and Chemical Characterization

The following recipe was used to synthesize three compound formulations within the cobalt-iron aluminate (CoₓFe_{1-x+y}Al_{2-y}O₄) compositional space: (1) x=0.40 and y=0, (2) x=0 and y=0, and (3) x=0 and y=0.40. For brevity, and to avoid implying the existence of a particular phase, these formulations are hereafter referred to as Co13Fe20Al67, Fe33Al67, and Fe47Al53, respectively. The methods outlined in this recipe were specifically tailored to ensure that the preparation of Fe33Al67 yielded high purity hercynite, which is conventionally achieved by subjecting homogeneous precursor mixtures of the proper cation ratio (i.e., 33 mol % Fe) to prolonged thermal treatments at high temperatures and low oxygen partial pressures. To homogeneously disperse metal cations, prior studies have considered—for example—mechanical mixing of Fe₂O₃ and Al₂O₃ powders, decomposing Fe and Al ammonium alums in solution, or physically combining metallic Fe with dehydrated Al(OH)₃. Here, however, a modified Pechini sol-gel method, commonly used in the synthesis of perovskites, was leveraged to ensure that cations were uniformly dispersed before calcination. First, using thermogravimetric analysis (NETZSCH, STA 449 F1 Jupiter), representative samples of Co(NO₃)₂·6H₂O, Fe(NO₃)₃·9H₂O, and Al(NO₃)₃·9H₂O (Sigma-Aldrich, ACS reagent, ≥98%) were dehydrated to identify the nominal wt. % of metal cations. Stoichiometric amounts of these metal nitrates, as prescribed by the desired cation ratio of each formulation, were then dissolved with dry citric acid monohydrate (C₆H₈O₇·H₂O, Fisher Scientific, Certified ACS) in 20 mL of deionized (DI) water. The molar ratio of C₆H₈O₇·H₂O to total metal cations was set to 3:2. The aqueous solution, contained within a glass beaker, was continuously stirred at 300 RPM for 2 hours under ambient conditions. Then, ethylene glycol (C₂H₆O₂, Fisher Scientific, Certified) was introduced at a ratio of 2 moles C₂H₆O₂ per mole C₆H₈O₇·H₂O to further promote homogeneity. After 10 minutes, the solution was slowly heated to 90° C., where temperature was maintained until complete gelification was attained; the rotation speed of the magnetic stirrer was progressively increased from 300 to 900 RPM during heating. After cooling, easily accessible material was transferred to two alumina combustion boats and air dried at 300° C. for 3 hours in a Lindberg Hevi-Duty tube furnace. Any remaining material adhered to the glass beaker surface was air dried in a drying oven (Fisher Scientific, Isotemp 737F) at 100° C. overnight. The resulting material was separated by formulation and drying approach and then ground with a mortar and pestle into a fine powder.

Thermal treatment consisted of three steps. First, each batch was reinserted into the Lindberg Hevi-Duty tube furnace and individually calcined in air at 850° C. for 24 hours to (1) pyrolyze any remaining organics and (2) form solid solutions that are primarily composed of binary metal oxides. Next, each solid solution was subsequently reduced to ensure that all components were of the spinel phase. Otherwise, the authors observed the persistence of impurities (e.g., metallic Fe or corundum) in the final product, in their case, synthetic hercynite. Here, reduction was performed for 6 hours at 900° C. and a pO₂ of approximately 10⁻¹⁴ bar. Lastly, each batch was subjected to a 24-hour calcination at 1380° C. and a pO₂ of approximately 10⁻¹⁰ bar; these conditions were selected with the intention of promoting the formation of hercynite. A portion of the resulting iron aluminate-based spinels were uniaxially cold-pressed at 2 tons for 120 seconds to form dense cylindrical pellets with the following dimensions: 6 mm diameter, 1-2 mm height, and 50-65 mg mass.

The last two reduction steps were conducted in a stagnation flow reactor, a device well suited for ensuring that samples experience a uniform gas composition. Here, the pO₂ of the system was accurately controlled by delivering a 15% CO/Ar mixture (Airgas, certified standard) with CO₂ (Airgas, grade 5.0) at different flow rates. By assuming equilibrium of CO₂ thermolysis (i.e., CO₂↔CO+½O₂), the pO₂ of the atmosphere surrounding the sample is determined according to Equation 1.

$$\frac{{p O}_{2}}{P°} = {( {K}_{r} ( T ) \frac{{p CO}_{2}}{p CO} )}^{2} = {( \frac{{K}_{CO} ( T )}{{K}_{{CO}_{2}} ( T )} \frac{{\dot{F}}_{{CO}_{2}}}{{\dot{F}}_{CO}} )}^{2} \qquad ( 1 )$$

Equilibrium constants for the formation of CO₂ and CO (i.e., K_{CO}_{₂} and K_{CO}, respectively) were obtained from NIST-JANAF thermochemical tables as a function of temperature (T); P ° is the standard pressure of 1 bar. Inlet mass flow rates of CO₂ and CO (i.e., \dot{F}_{CO}_{₂} and \dot{F}_{CO}, respectively) were standardized to 0° C. and 760 Torr. For calcination at 900° C. and 1380° C., the inlet CO₂/CO ratio was 11.5:1 and 1:4, respectively.

The iron aluminate-based materials were characterized by several techniques at different stages of the calcination process and after the experimental campaign. Powder X-ray diffraction (PXRD) was performed on a Bruker D8 Advance diffractometer equipped with a LYNXEYE XE-T detector and monochromatic Cu—Kα radiation; the generator voltage and tube current were 40 kV and 40 mA, respectively. The PXRD patterns were recorded at room temperature between 15° and 100° (2Θ) with a scan rate of 2° min⁻¹, step size of 0.007°, and time per step of approximately 40 s. Each measurement was processed with DIFFRAC.EVA software (Bruker AXS), which was employed to (1) conduct phase identification using reference patterns derived from the Crystallography Open Database (COD) and (2) correct for background effects observed at low diffraction angles (i.e., 2Θ<20°) that are introduced by the PMMA specimen holder. The Fe33Al67 and Fe47Al53 PXRD patterns were further analyzed with FullProf Suite software to enable accurate quantification of phase proportions. The peak profiles were modelled using COD standards and a pseudo-Voigt function, and the refined parameters included scale factor, atomic positions, occupancies, isotropic atomic displacement parameters, and lattice parameters. Scanning electron microscopy (SEM) and energy-dispersive X-ray spectroscopy (EDS) were performed using an FEI Nova NanoSEM 450 equipped with a silicon drift detector (Oxford Instruments, X-Max^{N}), which enabled morphological surface imaging and qualitative assessment of surface element homogeneity. The respective elemental compositions of the as-synthesized samples were quantified with inductively coupled plasma-optical emission spectrometry (ICP-OES) using an Avio 500 (Perkin Elmer). Prior to analysis, 100 mg powdered samples were subjected to microwave-assisted acid digestion (CEM Corporation, Discover SP-D 80), where complete dissolution was achieved with a combination of HCl, HNO₃, and HF (Fisher Chemical, TraceMetal™ Grade). To complex excess HF, a saturated solution of H₃BO₃ (Thermo Fisher Scientific, Trace Metal Basis) in ultrapure DI water (ELGA LabWater, PURELAB flex 2) was subsequently introduced into the digested solution, followed by further dilution with additional DI water until the concentration of total dissolved solids was less than 1000 mg L⁻¹.

### Thermal Analysis

The equilibrium behavior of the pelletized, iron aluminate-based samples was evaluated using a STA 449 F1 Jupiter thermal analyzer equipped with a vertically oriented sample carrier that enabled thermogravimetric (TG) measurements. A type S thermocouple, imbedded within the TG sample carrier, provided temperature measurements at the location of the sample (Tₛ). The exposed thermocouple junction directly supported a flat-plate alumina crucible, which was selected to reduce external mass transfer limitations to the pellets; a 6 mm sapphire disc was implemented between each pellet and crucible to prevent any interaction. Upstream of the sample chamber, O₂/Ar mixtures, which contained either 10% O₂ (Airgas, certified standard) or 0.2% O₂ (Airgas, certified standard), were diluted with additional Ar (Airgas, grade 5.0) via two electronic mass flow controllers (Bronkhorst, El-FLOW select) and a manual rotameter (Vögtlin Instruments, Q-Flow 140). Before initiating the experimental campaign, all flow controllers were calibrated (Mesa Labs, FlexCal Series) to ensure accurate delivery of the inlet gases (standardized to 25° C. and 760 Torr) and thus control the pO₂ within the sufficiently mixed sample chamber and hermetically sealed system. Regardless of flow configuration, the total volumetric flow rate (\dot{V}ₜₒₜ) was maintained at approximately 180 sccm, while the total pressure within the sample chamber remained at one atmosphere (i.e., ˜630 Torr for Boulder, Colorado), as outlet gases were exhausted to the ambient. Atmospheric pressure was recorded over the course of each experiment by referencing the measurements reported at the nearby Boulder Municipal Airport, courtesy of the National Weather Service. Any changes in product composition due to oxygen evolution or consumption were qualitatively monitored downstream of the reaction zone with a quadrupole mass spectrometer (NETZSCH, QMS 403C Aëolos).

Before each experiment, the pellets were fully oxidized at either 700° C. or 1100° C. and a pO₂ of approximately 10⁻² bar; preliminary tests confirmed that complete oxidation was achieved under these conditions, as denoted by the lack of mass gain and stabilization of the oxygen signal gradient. Experiments were then performed at a constant pO₂ between 10⁻² bar and 10⁻⁵ bar, and as a result, any relative change in the sample mass was directly imposed by heating or cooling to a different furnace reference temperature (T_{ref}); the rate of heating and cooling between T_{ref} was less than or equal to 15° C. min⁻¹, and Tₛ never deviated more than 6° C. from T_{ref}. This experimental procedure consisted of evaluating randomly selected T_{ref} from 1000° C. to 1400° C. (in 100° C. increments), where the duration of each isotherm was held for either 1 or 2 hours. For each experiment, samples were subjected to the aforementioned T_{ref} sequence twice, where each sequence was uniquely randomized. In addition, 700° C. isotherms were implemented at the initiation and completion of the overall experiment, as well as in between the two T_{ref} arrays. These lower temperature segments provided a temporal frame of reference for the higher-temperature, mass-relaxation tests, where greater amounts of oxygen evolution were expected for the considered pO₂ range. If the relative change in sample mass did not equilibrate within the allotted duration, a separate experiment was performed with elongated reactions to ensure thermodynamic equilibrium was attained for all temperatures. Here, the randomized temperature sequences were modified so that samples were only evaluated where equilibrium was not previously established. In these instances, the T_{ref} sequences were organized in ascending order. Regardless of method, to compensate for undesired buoyancy effects observed in the TG measurements, each experiment was immediately replicated in the absence of any reactive material.

### Computational

A thermodynamic analysis of the Fe—Al—O and Co—Fe—Al—O systems was performed using the software package FactSage (version 8.0) to calculate phase equilibria based on the principle of Gibbs free energy minimization. The calculations considered both solution (i.e., slag, corundum, spinel, and monoxide) and pure compound (i.e., gas and solid) databases, and each system was evaluated at a constant pressure (760 Torr) for different cation compositions (ζ), temperatures, and oxygen partial pressures.

A defect model was proposed to supplement the thermogravimetric measurements by providing insight into material behavior outside the range of conditions examined experimentally. Importantly, describing the effect of T and pO₂ on equilibrium is feasible with knowledge of only a few parameters, namely the standard molar enthalpy (ΔH̅^{o}) and entropy (ΔS̅^{o}) of relevant defect reactions. Herein, these thermodynamic state quantities were obtained by minimizing the sum of squared errors (SSE), as defined in Equation 2, between the model predictions and experimental results.

$$S S E = {\sum }_{{T}_{ref}} {\sum }_{{pO}_{2}} {( {δ}_{model} - δ )}^{2} \qquad ( 2 )$$

Comparisons were evaluated in terms of the degree of nonstoichiometry (δ), which for the latter is defined, according to Equation 3, as the product of the molar mass ratio of spinel (Mₛₜ) to oxygen (M_{O}) and the measured relative change in mass (m) between the equilibrium and stoichiometric states (denoted by subscripts eq and st, respectively) of the spinel.

$$δ = \frac{3 {M}_{st}}{4 {M}_{O}} ( \frac{{m}_{eq} - {m}_{st}}{{m}_{st}} ) \qquad ( 3 )$$

Note that, in this study, equilibrium was considered established only if (1) the furnace was set at an isothermal condition and (2) the change in mass with respect to time was less than a tenth of a microgram per minute. These criteria are mathematically represented in Equation 4.

$${t}_{eq} = t if \frac{{dT}_{ref} ( t )}{dt} = 0 ( °C {min}^{- 1} ) and \vert \frac{dm ( t )}{dt} \vert < 0.1 ( μ g {min}^{- 1} ) \qquad ( 4 )$$

Close agreement between theory and experiment, in addition to providing support for the proposed mechanism, allows for the determination of δ at any condition where the defect model assumptions remain valid. As a result, the range in which composition-dependent properties, such as the standard partial molar enthalpy (Δh̅ᵥ°) and entropy (Δs̅ᵥ°) of vacancy formation or consumption, are described is not limited by the scope of the experimental campaign. A thorough delineation of these thermodynamic state functions, in particular, is important, as according to Equation 5 Δh̅ᵥ° and Δs̅ᵥ° enable the equilibrium extent of reaction to be determined for a given T and pO₂ (i.e., without requiring explicit knowledge of the defect chemistry).

$$\frac{3}{4} ( Δ {\overline{h}}_{v}^{°} ( δ ) - T Δ {\overline{s}}_{v}^{°} ( δ ) ) = - \frac{1}{2} RT ln ( \frac{{p O}_{2}}{P°} ) \qquad ( 5 )$$

Obtaining these properties involves manipulating Equation 5 into the linear form of the van't Hoff equation, plotting −ln(\sqrt{pO₂/P°}) versus 1/T, and calculating the slope and intercept of the regression line as a function of composition (i.e., δ); note that if the plots exhibit a linear relationship, Δh̅ᵥ° and Δs̅ᵥ° can be assumed independent of temperature. The key assumptions underlying this derivation include ideal gas behavior and unity activity of the solid as the change in δ approaches zero.

### Water Splitting

The effectiveness of an oxide for facilitating thermochemical water splitting is measured by the change in the extent of reaction (i.e., Δδ) that is achieved between reduction and oxidation steps. To predict Δδ, which is proportional to the cyclic amount of oxygen and hydrogen evolved from the oxide, one must first establish the attainable operating conditions of each step, particularly the pO₂, as T is independently controlled. At ambient pressure (i.e., 1 bar), the inlet pO₂ of the reduction reaction is defined by the oxygen content in the inert sweep gas, which is typically below 10 ppm. Conversely, the inlet pO₂ of the oxidation reaction is determined according to the temperature-dependent equilibrium of water thermolysis (i.e., H₂O↔H₂+½O₂). Assuming an ideal gas mixture, analogous to Equation 1, the equilibrium constant for the formation of H₂O (i.e., K_{H}_{₂}_{O}) may be related to the partial pressures of participating gases as shown in Equation 6.

$$\frac{1}{{K}_{{H}_{2} O} ( T )} = \frac{{pH}_{2}}{{pH}_{2} O} {( \frac{{p O}_{2}}{P°} )}^{1 / 2} = \frac{{n}_{i , {H}_{2}} + ε}{{n}_{i , {H}_{2} O} - ε} {( \frac{1 / 2 ε}{{n}_{i , {H}_{2}} + {n}_{i , {H}_{2} O} + 1 / 2 ε} \frac{P}{P°} )}^{1 / 2} \qquad ( 6 )$$

Here, the reaction coordinate (ε) was introduced in order to obtain a unique solution for pO₂, provided that the initial number of moles of each species (nᵢ) and the independent reaction conditions (i.e., T and P) are specified; K_{H}_{₂}_{O} was obtained from NIST-JANAF thermochemical tables. Note that in an open system, where any oxygen or hydrogen evolved from the oxide is swept away, at equilibrium, the pO₂ at the inlet and outlet of either reaction chamber is constant. In this limit, for a particular set of reduction conditions (i.e., T and pO₂), the thermodynamic capacity of an oxide for the production of hydrogen can be quantified solely as a function of oxidation temperature, as the value of pO₂ calculated from Equation 6 is entirely temperature-dependent when only steam is introduced into the system (i.e., n_{i,H}_{₂}=0). It is arguably more relevant, however, to consider how—in practice—oxides often encounter environments where the inlet steam is diluted with product hydrogen (i.e., H₂O:H₂<∞), thus reducing the attainable pO₂ of the oxidation reaction. Therefore, using Equation 6, the influence of H₂ on the equilibrium extent of oxidation was also assessed by calculating the corresponding pO₂ of water thermolysis including some quantity of H₂ (i.e., n_{i,H}_{₂}>0). Regardless of the input steam-to-hydrogen ratio, considering the aforementioned assumptions, predicting Δδ for an oxide simply involves (1) locating the equilibrium extents of reduction and oxidation (i.e., δ_{red} and δₒₓ, respectively) at the established operating conditions and (2) determining their difference.

### Mechanistic Insight and Defect Model

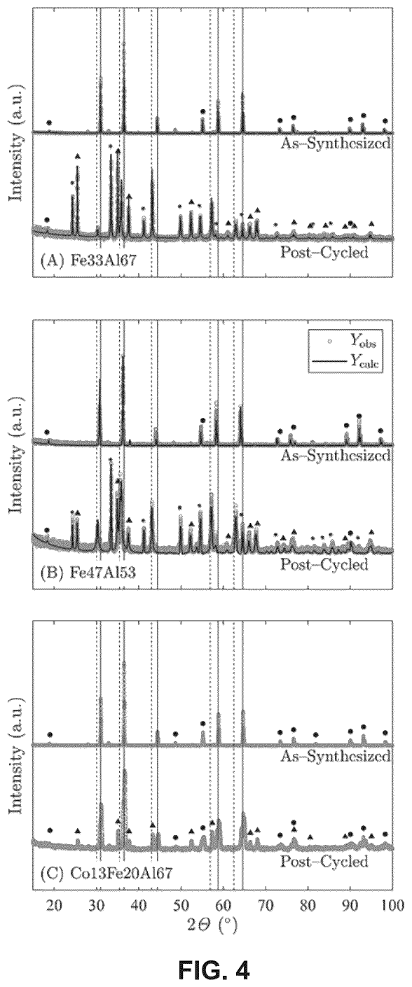

The X-ray diffractograms of the iron aluminate-based powders following synthesis and the experimental campaign are shown in FIG. 4. Superimposed on the plots are the characteristic diffraction peaks of FeAl₂O₄ and Fe₃O₄ as denoted by the solid and dashed vertical lines, respectively; the diffraction peaks of the former are located at higher 2Θ values, since the lattice parameters of Fe₃O₄ are larger (i.e., a=b=c=8.15 Å and 8.40 Å for FeAl₂O₄ and Fe₃O₄, respectively). Qualitative phase analysis indicates that, after calcination at 1380° C. in a CO/CO₂ atmosphere (pO₂≈10⁻¹⁰ bar), the Fe33Al67 sample was primarily composed of the FeAl₂O₄ phase, while the Fe47Al53 sample—which exhibits peaks in between the characteristic peaks of each spinel—likely contained a higher proportion of Fe₃O₄. After the experimental campaign, where the samples were exposed to oxygen partial pressures as high as 10⁻² bar, peaks assigned to corundum and hematite were also observed for both Fe33Al67 and Fe47Al53. Analysis of the Co13Fe20Al67 sample revealed similar behavior: a non-spinel phase (e.g., Al₂O₃) was only observed after subjecting the sample to more oxidizing conditions. Note that for cobalt-containing formulations, the spinel phase may consist of CoAl₂O₄, Co₃O₄, FeAl₂O₄, and Fe₃O₄; the lattice parameters of CoAl₂O₄ and Co₃O₄ are near that of FeAl₂O₄ (i.e., a=b=c=8.10 Å and 8.08 Å for CoAl₂O₄ and Co₃O₄, respectively).

To quantify the phase composition of, in particular, the Fe33Al67 and Fe47Al53 samples, a multiphase Rietveld refinement of the PXRD data was performed. The calculations, shown as black lines in FIG. 4, exhibit close agreement with the observed diffraction patterns as indicated by the final goodness-of-fit (χ²), which converged to a value less than eight for all refinements. Both iron aluminates were confirmed to be of the spinel phase after calcination and consist of spinel, corundum, and hematite phases after the experimental campaign; the phase compositions and structural refinement parameters are presented in Table 1. Regarding Fe33Al67, the lattice parameters are close to 8.15 Å (i.e., the value for FeAl₂O₄), thus indicating that, as desired, the as-synthesized sample was nearly phase pure. The refinement also indicated that the lattice parameters of the as-synthesized Fe47Al53 sample were larger—a consequence of a greater amount of Fe₃O₄ (i.e., 26.8 wt. %). After the experimental campaign, the spinel lattice parameters of both samples increased to approximately 8.35 Å, as the proportion of Fe₃O₄ relative to FeAl₂O₄ increased. Therefore, although the effects of defects may contribute to changes in peak position, it is evident that the spinel peaks shift to lower 2Θ values as the samples oxidize and the ratio of Fe₃O₄ to other spinels concomitantly increases.

Table 2 presents the elemental compositions of the as-synthesized iron aluminate-based materials, as determined by ICP-OES. These results, which are all near their respective target values, also agree with the elemental compositions calculated from the corresponding phase compositions reported in Table 1. According to the Rietveld refinement, the Fe33Al67 sample consists of 0.34 mol_{Fe} mol_{c}⁻¹ and 0.66 mol_{Al} mol_{c}⁻¹, while the Fe47Al53 sample consists of 0.48 mol_{Fe} mol_{c}⁻¹ and 0.52 mol_{Al} mol_{c}⁻¹.

TABLE 1
Phase composition (wt. %) of Fe33Al67 and Fe47Al53
following synthesis and the experimental campaign,
as determined by multiphase Rietveld refinement.

| | Fe33Al67 | | Fe47Al53 | |
|---|---|---|---|---|
| Phase | As-Synthesized | Post-Cycled | As-Synthesized | Post-Cycled |
| FeAl₂O₄ | 98.9 | 4.2 | 73.2 | 18.7 |
| Fe₃O₄ | 1.1 | 0.6 | 26.8 | 9.9 |
| Fe₂O₃ | — | 24.9 | — | 20.1 |
| Al₂O₃ | — | 70.3 | — | 51.3 |

TABLE 2
Elemental composition of the as-synthesized iron aluminate-based
materials as determined by ICP-OES.

| | Co13Fe20Al67 | | Fe33Al67 | | Fe47Al53 | |
|---|---|---|---|---|---|---|
| | | [mol | | [mol | | [mol |
| Element | [mg/L] | mol_{c}⁻¹] | [mg/L] | mol_{c}⁻¹] | [mg/L] | mol_{c}⁻¹] |
| Co | 336 | 0.17 | — | — | — | — |
| Fe | 388 | 0.20 | 655 | 0.35 | 869 | 0.47 |
| Al | 574 | 0.63 | 594 | 0.65 | 467 | 0.53 |

To provide further insight into the results of PXRD and Rietveld refinement, phase diagrams of the Fe—Al—O and Co—Fe—Al—O systems were constructed, as shown in FIG. 4. Under the examined conditions, the following phases are present in the Fe—Al—O system: a solid solution (ss) of spinels (i.e., FeAl₂O₄ and Fe₃O₄), a solid solution of corundum, a solid solution of hematite, and a solid solution of an intermediate compound (1:1 Fe₂O₃:Al₂O₃). The spinel region indicates the spinel phase, the equilibrium region indicates the equilibrium of spinel and corundum phases, and the unshaded regions represent the conditions in which the iron aluminates are fully oxidized, as evidenced by the presence of hematite. The solid line between the equilibrium and unshaded regions—which is hereafter referred to as the solid-solution phase boundary—remains constant over a wide range of iron cation compositions (e.g., from 0.125 to 0.5). In contrast, the phase boundary between the spinel and equilibrium regions shifts towards lower temperatures and higher oxygen partial pressures as ζ increases; the region created by showing the shift in phase boundary (e.g., from ζ=0.35 to ζ=0.45 as denoted by the dashed and dot-dashed lines, respectively) is shaded, a combination of spinel and equilibrium, to indicate overlap. In general, the Co—Fe—Al—O system exhibits similar behavior, although only three phases are present: a solid solution of spinels (i.e., CoAl₂O₄, Co₃O₄, FeAl₂O₄, and Fe₃O₄), a solid solution of corundum, and a solid solution of hematite. Here, both phase boundaries—including that between the equilibrium and uncolored regions—change as a function of cobalt cation composition, shifting towards lower temperatures and higher oxygen partial pressures as ζ increases. Thus, the introduction of cobalt in iron aluminates reduces the temperature required for the transition from the oxidized state into a reduced one. The results of these calculations are corroborated by the observations of FIG. 4, such as the appearance of corundum and/or hematite in the post-cycled samples, as the final step of the experimental campaign involved rapid cooling to room temperature under oxygen partial pressures as high as 10⁻² bar.

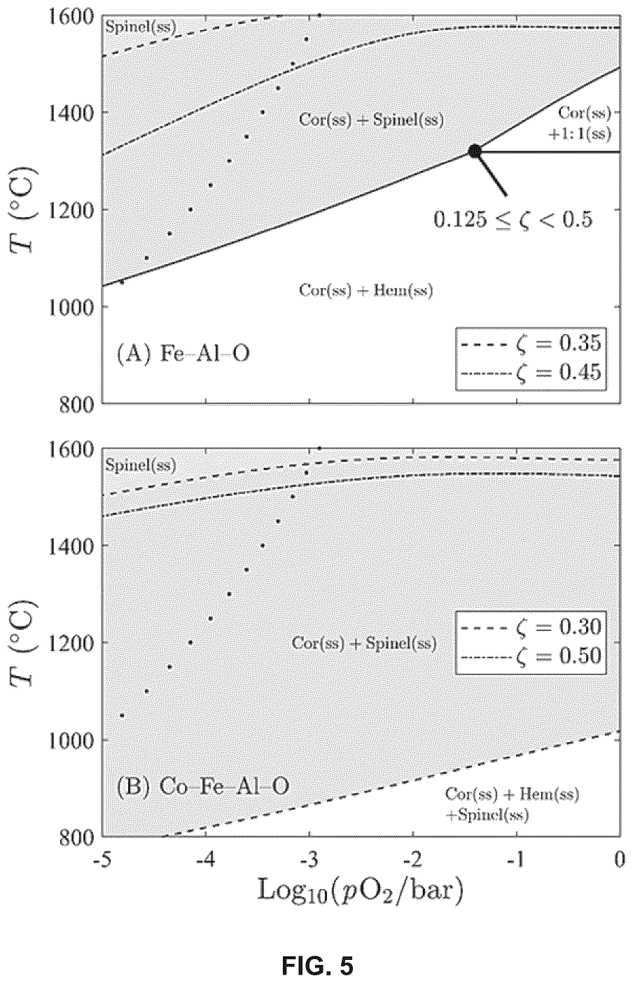

FIGS. 4 and 5 indicate that, contrary to previous claims, the redox behavior of iron aluminate-based materials cannot be solely attributed to hercynite or a mixed cobalt-iron aluminate compound. Otherwise, phase-pure hercynite, although metastable under ambient conditions, would not rapidly revert back to its original constituents (i.e., Fe₂O₃ and Al₂O₃) once exposed to a sufficiently oxidizing environment at elevated temperatures. Instead, under conditions relevant to the isothermal dissociation of H₂O (see symbols in FIG. 5), iron aluminate-based materials exist as a solid solution composed primarily of magnetite and hercynite spinels. While magnetite is individually incapable of producing appreciable amounts of hydrogen, when combined with hercynite, the altered equilibrium of the solid solution notably enables water splitting. This phenomenon—a consequence of the change in Gibbs free energy due to mixing—is analogous to the effect of inert zirconia on the thermodynamic properties of ceria; namely, ceria-zirconia solid solutions exhibit markedly greater extents of reduction than that of undoped ceria.

Therefore, in accordance with the established defect structure of iron oxides at high oxygen activities, we assign cation—not oxygen—vacancies as the predominant point defect responsible for the water-splitting ability of iron aluminate-based materials. The general chemical reaction for the removal of oxygen (i.e., reduction) from, for example, iron aluminate spinel solid solutions may then be written as shown in Equation 7.

$$( \frac{3 - {δ}_{f}}{4 Δ δ} ) {( {Fe}_{ζ} {Al}_{1 - ζ} )}_{3 - {δ}_{i}} {O}_{4} ↔ ( \frac{3 - {δ}_{i}}{4 Δ δ} ) {( {Fe}_{ζ} {Al}_{1 - ζ} )}_{3 - {δ}_{f}} {O}_{4} + \frac{1}{2} {O}_{2} ( g ) \qquad ( 7 )$$

Note that δ, the deviation from stoichiometry, is a measure of the concentration of crystal lattice defects, where the subscripts i and f refer to the initial and final states, respectively. To drive this reaction in the forward direction, Δδ—defined as the difference between δᵢ and δ_{f}—must be positive, thus implying that, unlike materials that accommodate oxygen vacancies, the extent of reduction increases with decreasing δ. In other words, the removal of lattice oxygen requires that cation vacancies are consumed, which, as described using Kröger-Vink notation in Equation 8, is compensated by the conversion of neighboring Fe³⁺ cations into Fe²⁺ cations to maintain charge neutrality.

$$2 {Fe}_{Fe}^{} + {V}_{Fe}^{″} + {O}_{O}^{x} ↔ 2 {Fe}_{Fe}^{x} + 1 / 2 {O}_{2} ( g ) \qquad ( 8 )$$

According to the law of mass action, if the activity coefficients are assumed to be unity, the lattice species introduced above can be related as follows:

$${K}_{1} ( T ) = \frac{{[ {Fe}_{Fe}^{x} ]}^{2} \sqrt{{p O}_{2} / P°}}{{[ {Fe}_{Fe}^{} ]}^{2} [ {V}_{Fe}^{″} ] [ {O}_{O}^{x} ]} \qquad ( 9 )$$

where K₁ is the temperature-dependent equilibrium constant for the reaction presented in Equation 8, and the square brackets denote concentration per lattice molecule.

Although Equation 9 is capable of qualitatively interpreting the bulk nonstoichiometry of iron aluminate spinel solid solutions, in order to more accurately represent the underlying physics, it was necessary to consider the temperature-dependent site preference of lattice species. In the spinel structure, cations (and vacancies) can be coordinated to either four or six oxygen anions, depending on whether a tetrahedral or octahedral site is occupied. The distribution of cations between sites follows the general formula A_{1-λ}B_{λ}(A_{λ/2}B_{1-λ/2})₂O₄, where symbols A and B represent divalent (e.g., Fe²⁺) and trivalent (e.g., Fe³⁺ and Al³⁺) cations, parentheses denote the octahedral sublattice, and λ refers to the degree of inversion. At room temperature, magnetite adopts a predominantly inverse (λ=1) distribution, while hercynite adopts a predominantly normal (λ=0) one; however, as temperature increases, tetrahedral and octahedral cations exchange their lattice sites (0<λ<1)—a consequence of the entropic effect. Herein, the disordering of the spinel structure was described by introducing the following reactions, which are also written in Kröger-Vink notation.

$${Fe}_{Fe}^{} + ( {Fe}_{Fe}^{x} ) ↔ {Fe}_{Fe}^{x} + ( {Fe}_{Fe}^{} ) \qquad ( 10 a )$$

$${Fe}_{Fe}^{x} + ( {Al}_{Al}^{x} ) ↔ {Al}_{Fe}^{} + ( {Fe}_{Al}^{′} ) \qquad ( 10 b )$$

$${Fe}_{Fe}^{} + ( {V}_{Fe}^{″} ) ↔ {V}_{Fe}^{″} + ( {Fe}_{Fe}^{} ) \qquad ( 10 c )$$

To reduce the number of model equations, only exchanges between lattice species with different charges (or oxidation states) were considered, namely a tetrahedral Fe³⁺ with an octahedral Fe²⁺, a tetrahedral Fe²⁺ with an octahedral Al³⁺, and a tetrahedral Fe³⁺ with a doubly ionized octahedral vacancy. For each reaction presented in Equation 10, the law of mass action can be similarly applied to relate the concentrations of corresponding lattice species to a unique equilibrium constant; these relationships are shown in Equation 11.

$${K}_{2} ( T ) = \frac{[ {Fe}_{Fe}^{x} ] [ ( {Fe}_{Fe}^{} ) ]}{[ {Fe}_{Fe}^{} ] [ ( {Fe}_{Fe}^{x} ) ]} \qquad ( 11 )$$

$${K}_{3} ( T ) = \frac{[ {Al}_{Fe}^{} ] [ ( {Fe}_{Al}^{′} ) ]}{[ {Fe}_{Fe}^{x} ] [ ( {Al}_{Al}^{x} ) ]}$$

$${K}_{4} ( T ) = \frac{[ {V}_{Fe}^{″} ] [ ( {Fe}_{Fe}^{} ) ]}{[ {Fe}_{Fe}^{} ] [ ( {V}_{Fe}^{″} ) ]}$$

In addition, the aforementioned chemical reactions must obey the following bulk conservation equations.

Tetrahedral site balance:

$$[ {Fe}_{Fe}^{} ] + [ {Fe}_{Fe}^{x} ] + [ {V}_{Fe}^{″} ] + [ {Al}_{Fe}^{} ] = 1 \qquad ( 12 )$$

Octahedral site balance:

$$[ ( {Fe}_{Fe}^{} ) ] + [ ( {Fe}_{Fe}^{x} ) ] + [ ( {V}_{Fe}^{″} ) ] + [ ( {Al}_{Al}^{x} ) ] + [ ( {Fe}_{Al}^{′} ) ] = 2 \qquad ( 13 )$$

Oxygen site balance:

$$[ {O}_{O}^{x} ] = 4 \qquad ( 14 )$$

$$Tetrahedral electroneutrality : [ {Fe}_{Fe}^{} ] + [ {Al}_{Fe}^{} ] = 2 [ {V}_{Fe}^{″} ] \qquad ( 15 )$$

$$Octahedral electroneutrality : [ ( {Fe}_{Fe}^{} ) ] = 2 [ ( {V}_{Fe}^{″} ) ] + [ ( {Fe}_{Al}^{′} ) ] \qquad ( 16 )$$

$$Mass balance : [ ( {Al}_{Al}^{x} ) ] + [ {Al}_{Fe}^{} ] = 3 ( 1 - ζ ) \qquad ( 17 )$$

Although evidence of defect associations have been observed in iron oxides, particularly wüstite, the formation of such clusters in the Fe—Al—O system remains unresolved, and thus point defects were assumed to form ideal solutions on their respective sublattices. Together, Equation 9 and Equations 11 through 17 define the model used to describe the redox behavior of iron aluminates under conditions relevant to two-step thermochemical fuel production. For a particular T, pO₂, and ζ, the concentrations of all lattice species can be determined if initial guesses for the standard molar enthalpies (ΔH̅°) and entropies (ΔS̅°) that comprise each equilibrium constant (i.e., K₁, K₂, K₃, and K₄) are specified. Consequently, δ_{model}—a summation of the sublattice vacancy concentrations (i.e., [(V_{Fe}″)] and [V_{Fe}″])—can be calculated, thus enabling comparisons with experimental data as described herein. In this study, the reported thermodynamic state quantities were obtained by using fmincon, a sequential quadratic programming (SQP) algorithm available in MATLAB, to manipulate the set of initial guesses until the global minimum of Equation 2 was found. This approach was validated by reproducing existing defect models for the formation of oxygen vacancies in ceria and a doped lanthanum manganite and demonstrating that the results are in excellent agreement with those obtained using other methods.

It is important to note that while the mechanistic insight presented herein is relevant for cobalt-containing formulations, the methods may not capable of quantifying δ without additional information, as both Co₃O₄ and CoAl₂O₄ exist when cobalt-iron aluminates are fully oxidized (see FIG. 5). As a result, the proposed defect model was solely developed for the iron aluminates examined herein (i.e., Fe33Al67 and Fe47Al53).

### Thermodynamic Characterization

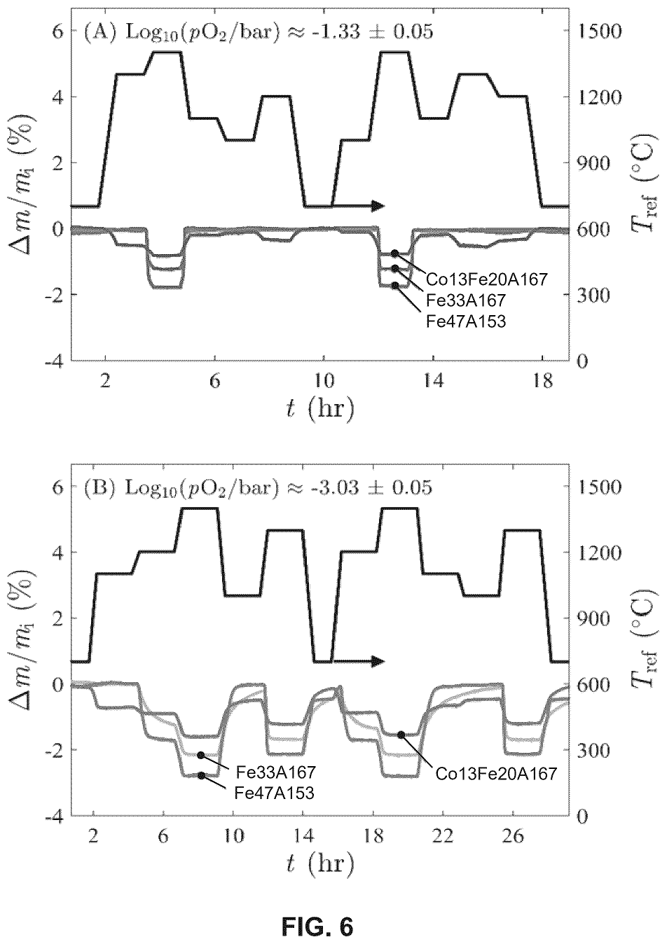

FIG. 6 shows the thermogravimetric response of pelletized Co13Fe20Al67, Fe33Al67, and Fe47Al53 samples when subjected to changes in temperature at different oxygen partial pressures. For each sample, the extent of reduction, expressed as the percent relative change in mass from the fully oxidized state (Δm/mᵢ), increased with increasing T_{ref} and decreasing pO₂ as expected. Furthermore, formulations with greater amounts of iron (i.e., the primary redox-active element) exhibited greater extents of reduction if compared under conditions where spinel solid solutions exist (see FIG. 5). Otherwise, as can be seen in FIG. 6(A) for temperatures less than 1400° C., the iron aluminates Fe33Al67 and Fe47Al53 remained in the fully oxidized state (i.e., a solid solution of corundum and hematite), whereas the cobalt-containing counterpart Co13Fe20Al67 was appreciably reduced—even at temperatures as low as 1000° C. This unique aspect of the Fe—Al—O system led to slower kinetics when approaching or crossing the solid-solution phase boundary, especially for Fe33Al67 at low oxygen partial pressures (FIG. 6(B)). As a result, separate experiments were performed to ensure equilibrium was attained at all conditions.

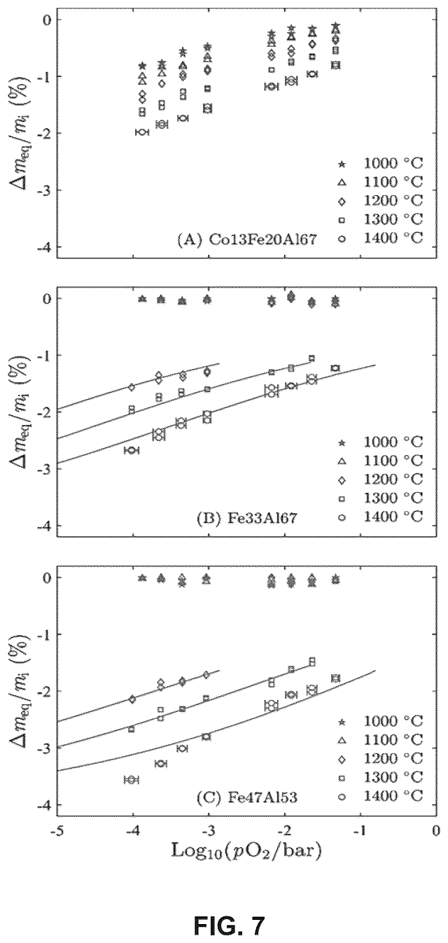

The experimental results, such as those displayed in FIG. 6, were evaluated according to the criteria defined in Equation 4 to characterize equilibria as a function of isothermal temperature and oxygen partial pressure; a summation of the equilibrium thermogravimetric measurements is presented in FIG. 7. Here, the effect of cation composition on the redox behavior of the samples and, in particular, the location of the solid-solution phase boundary is further evident. For example, while the equilibrium state of Co13Fe20Al67 is dependent on pO₂ throughout the examined conditions, such dependence is only observed for Fe33Al67 and Fe47Al53 at temperatures above 1100° C. (i.e., once the spinel solid solution phase is established). This phase transition—illustrated in FIG. 5 and described by the chemical reaction presented in Equation 18—is indicated by a significant change in mass over a narrow range of pO₂, as seen for both Fe33Al67 and Fe47Al53 (FIGS. 7(B) and 7(C), respectively) at 1300° C. between approximately 2×10⁻² and 5×10⁻² bar.

$$ζ {Fe}_{2} {O}_{3} + ( 1 - ζ ) {Al}_{2} {O}_{3} ↔ \frac{2}{3 - δ} {( {Fe}_{ζ} {Al}_{1 - ζ} )}_{3 - δ} {O}_{4} + \frac{1}{2} ( \frac{1 - 3 δ}{3 - δ} ) {O}_{2} ( g ) \qquad ( 18 )$$

The standard molar enthalpies and entropies used to generate the reported model predictions (solid lines) are listed in Table 3. As expected, regardless of the iron aluminate composition, the defect reactions responsible for the removal of oxygen (Equation 8) and the exchange between tetrahedral Fe²⁺ and octahedral Al³⁺ sites (Equation 10b) are endothermic. Furthermore, the standard molar properties of the latter indicate that—in accordance with the known preference of Al³⁺ for octahedral coordination—the reaction tends towards the left (i.e., K₃<<1 at practicable temperatures). These observations and the close agreement between the experimental data and the thermodynamic (phase diagram and defect model) calculations support the validity of the proposed defect mechanism, which asserts that the water-splitting ability of iron aluminate-based materials is attributed to (1) the existence of cation vacancies and (2) the interaction of two or more spinels in solid solution. Note that the model is only applicable where the spinel solid solution phase is expected.

To improve figure clarity, since the uncertainties in the oxygen partial pressure and percent relative change in mass are independent of temperature, error bars are only depicted for results at 1400° C.; where not shown, errors are within the size of the symbols.

TABLE 3
Standard molar enthalpy and entropy of the defect reactions
associated to cation vacancy consumption and cation exchange
in iron aluminate spinel solid solutions.

| | Extracted Fitting | | |
|---|---|---|---|
| Equation | Parameter | Fe33Al67 | Fe47Al53 |
| 8 | ΔH̅₁° (kJ mol⁻¹) | 253.69 | 321.81 |
| | ΔS̅₁° (J mol⁻¹ K⁻¹) | 124.09 | 188.51 |
| 10a | ΔH̅₂° (kJ mol⁻¹) | −70.05 | −414.88 |
| | ΔS̅₂° (J mol⁻¹ K⁻¹) | −20.63 | −259.68 |
| 10b | ΔH̅₃° (kJ mol⁻¹) | 103.45 | 541.80 |
| | ΔS̅₃° (J mol⁻¹ K⁻¹) | −63.19 | 226.77 |
| 10c | ΔH̅₄° (kJ mol⁻¹) | 184.67 | −241.04 |
| | ΔS̅₄° (J mol⁻¹ K⁻¹) | 162.14 | −143.81 |

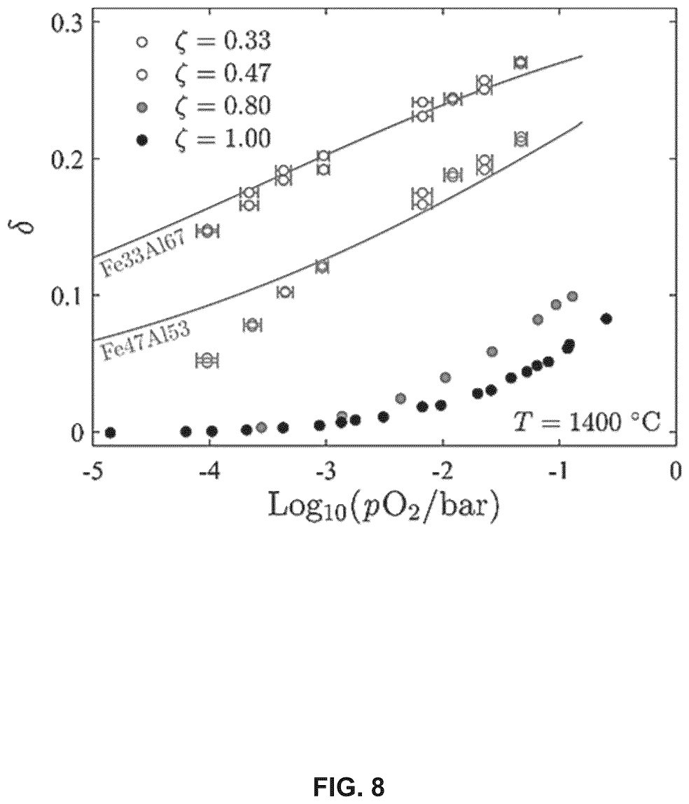

In FIG. 8, the equilibrium thermogravimetric measurements and corresponding defect model predictions for Fe33Al67 and Fe47Al53 are displayed with respect to δ and compared with relevant data extracted from literature at 1400° C. Regardless of the iron aluminate composition, δ (i.e., the extent of oxidation) increases with increasing pO₂, consistent with materials such as magnetite (ζ=1) that are known to accommodate cation vacancies. For a given pO₂, δ also increases as the proportion of redox-active iron (ζ) decreases, thus affirming that the presence of aluminum constrains the attainable extent of reduction. Notably, only compositions that contain high amounts of aluminum (ζ<0.5) exhibit the behavior necessary for facilitating water splitting at 1400° C., namely a positive slope at the equilibrium pO₂ of water thermolysis (in this case, 3.84×10⁻⁴ bar).

Physically, the formation of cation vacancies is accompanied by the outward diffusion of cations—the phenomenon responsible for the well-known growth of layered scales on iron and iron oxides under highly oxidizing conditions. Under reducing conditions, when cation vacancies are consumed, the direction of cation diffusion shifts inward, and in the limit that, for example, magnetite approaches stoichiometry (i.e., δ=0) interstitials become the predominant point defect. While multiphase scale growth can be avoided with the introduction of aluminum (due to the formation of stable solid solution phases), the transition from a vacancy-mediated (δ>0) to an interstitial-mediated (δ<0) mechanism in magnetite may also occur in iron aluminates and thus explain the discrepancy between the measurements and thermodynamic predictions at low δ.

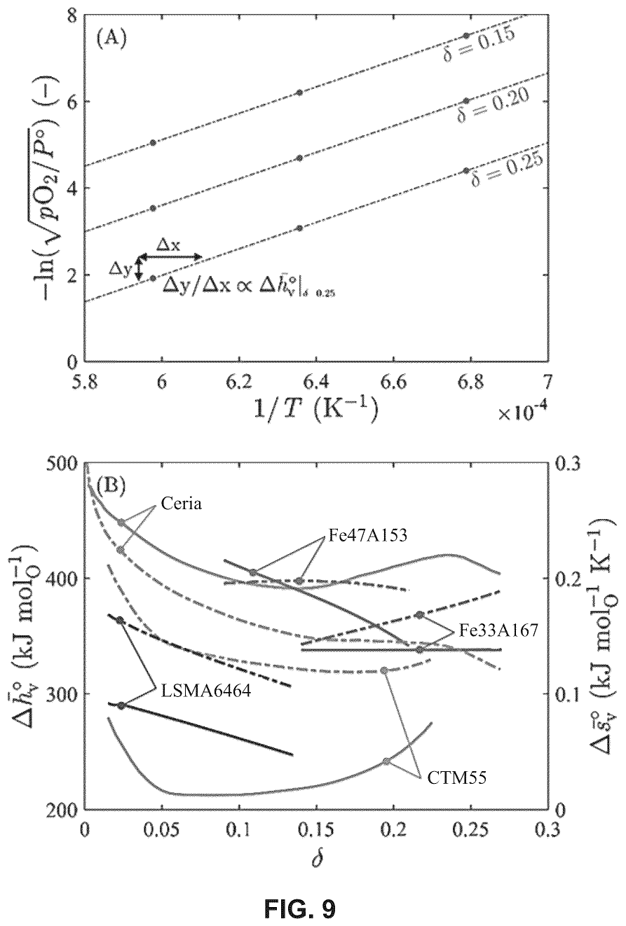

Defining the standard partial molar enthalpy and entropy of reduction (or oxidation) of a metal oxide allows for the determination of thermodynamic equilibrium at a known T and pO₂, without requiring an understanding of the defect chemistry. An illustration of the procedure to obtain such properties is presented in FIG. 9 (A), which demonstrates that Δh̅ᵥ°, for example, can be extracted from the slope of the best fit to the model data if plotted according to the linear form of the van't Hoff equation at constant composition. For context, the thermodynamic state functions developed for the reduction of Fe33Al67 and Fe47Al53 are compared in FIG. 9 (B) with those previously reported for the reduction of other candidate materials, namely ceria, LSMA6464, and CTM55. In general, the iron aluminates examined in this study exhibit standard partial molar properties that exceed that of the considered perovskites and, at some nonstoichiometries, even surpass that of ceria. This attractive combination of Δh̅ᵥ° and Δs̅ᵥ° implies that the temperature swing required for each redox reaction to proceed spontaneously is much smaller for the iron aluminates and ceria than that of LSMA6464 and CTM55. While noteworthy, the criteria that a material possesses large enthalpic and entropic changes is not entirely appropriate if the aim is to operate isothermally; here, the material that elicits the largest Δδ within the attainable range of pO₂ (i.e., between 10⁻⁵ to 10⁻³ bar) will benefit most in terms of efficiency—a consequence of greater fuel yields.

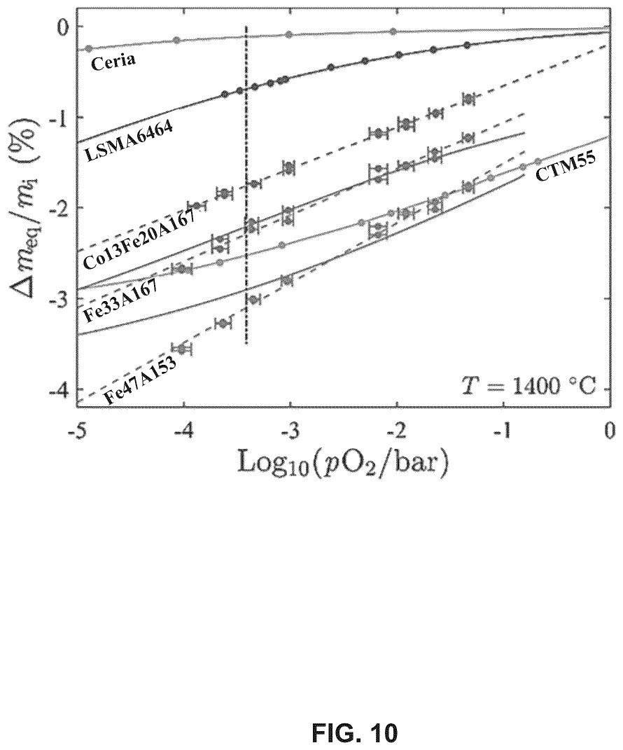

FIG. 10 shows the redox behavior of several candidate materials as a function of oxygen partial pressure at 1400° C. To ensure a fair comparison, results are expressed as the percent relative change in mass (or oxygen content) between the fully oxidized and equilibrium states, as the interpretation of δ is dependent on the types of defects that a material accommodates. The vertical dot-dashed line represents the maximum pO₂ that is attainable for water splitting at 1400° C. and 1 bar (see Equation 6), and thus, when operating isothermally, the reduction step must be initiated at a lower pO₂ in order to produce hydrogen. Quantifying the cyclic capacity of a material for the production of, in this case, hydrogen involves determining the vertical distance between the oxygen content at the reduction and oxidation conditions. As a result, for a given T and reduction pO₂, the material with the highest slope (i.e., change in Δm_{eq}/mᵢ per unit change in pO₂) will result in the highest yield. Although the data suggest that the slopes observed for the iron aluminate-based materials increase with increasing iron content, the trend is obscured by the discrepancy between the measurements and thermodynamic predictions at low δ. Therefore, linear approximations (dashed lines) were included to provide additional insight at the temperatures evaluated experimentally. Despite this discrepancy, it is evident that the iron aluminate-based materials exhibit slopes that exceed that of ceria and the considered perovskites and are thus more desirable candidates for isothermal redox cycling at 1400° C.

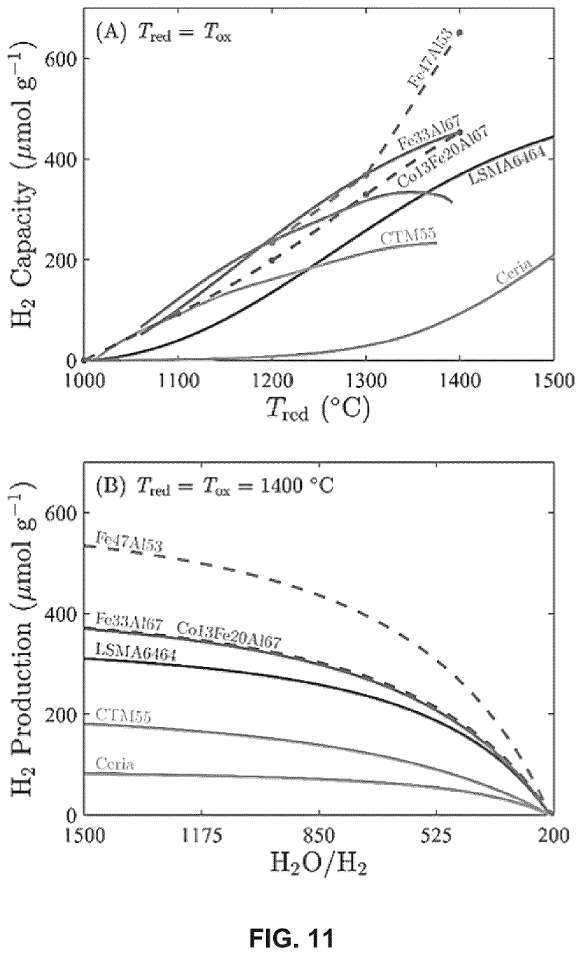

The thermochemical water-splitting performance of the candidate redox materials under isothermal conditions is examined in FIG. 11. In general, for isothermal operation, the thermodynamic capacity of an oxide for the production of hydrogen (FIG. 11(A)) increases with increasing temperature, as the oxidation pO₂—determined according to the equilibrium of water thermolysis at 1 bar—concomitantly increases. Notably, the highest capacities are observed for the iron aluminate-based materials, a consequence of possessing partial molar properties that uniquely enable large changes in reaction extent within the attainable range of pO₂ (see FIG. 10). At 1400° C., for example, Fe33Al67 is capable of producing over 450 μmol g⁻¹ of hydrogen, whereas LSMA6464—a perovskite predicted to perform efficiently under isothermal conditions—cannot exceed 370 μmol g⁻¹; the linear approximations suggest that the capacity of Fe47Al53 likely surpasses that of that Fe33Al67. Higher capacities for the production of hydrogen imply that materials are more tolerant of conditions expected in practice, where the amount of steam delivered must be constrained to reduce sensible heating penalties and improve efficiency. As can be seen in FIG. 11(B), the materials that exhibit the highest capacities (i.e., the iron aluminate-based materials) are still effective under “high conversion” conditions, producing over 200 μmol g⁻¹ when exposed to steam-to-hydrogen ratios as low as 500:1. Note that increasing the hydrogen yield while maintaining a high reactant conversion (i.e., H₂O/H₂<500:1) is possible if the reduction step is initiated at a lower pO₂; in this comparison, all yields converge at a 200:1 steam-to-hydrogen ratio, as the oxidation pO₂ at this condition is less than that defined for reduction (i.e., 10 ppm residual oxygen).

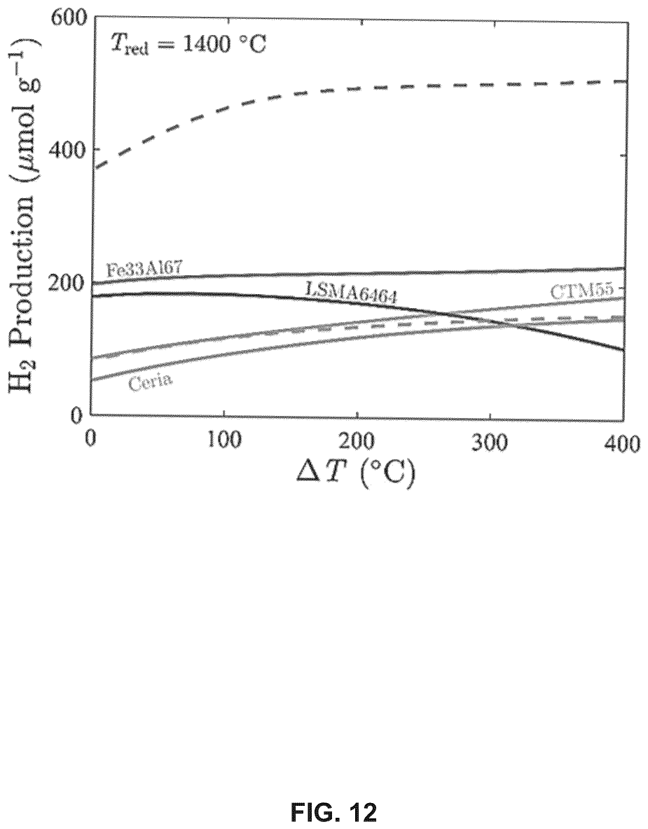

To provide further context for the significance of the, for example, iron aluminate performance under isothermal conditions, results are also presented as a function of temperature swing, as shown in FIG. 12. For water splitting with high conversion (i.e., H₂O/H₂=500:1), Fe33Al67—when operated isothermally at 1400° C.—is capable of exceeding the hydrogen yields of the oxygen vacancy-mediated alternatives following a 400° C. (or less) temperature swing. The examined alternatives include ceria, which is largely recognized as the benchmark material, and CTM55, a recently-developed perovskite marketed as having “outstanding properties” for two-step thermochemical fuel production. Notably, if lower conversion is permitted (e.g., H₂O/H₂=1500:1), the potential for higher yields with Fe33Al67 is much greater than with ceria, as ceria operates near its fully oxidized state at lower temperatures. The ability to isothermally outperform materials well suited for temperature-swing operation implies that solar-to-hydrogen conversion with iron aluminate-based materials will be more efficient than the conventional approach, as comparable yields are attainable without incurring excessive energy losses from heating and cooling between redox regimes.

Low-cost iron aluminate-based materials were characterized to ascertain the extent of performance under such conditions. Using thermogravimetry, the equilibrium extent of reaction was quantified as a function of cation composition, temperature, and oxygen partial pressure. The measurements were supplemented with a defect model to provide insight into behavior outside the scope of the experimental campaign, as well as clarify previous misconceptions regarding the mechanism by which these materials operate. Guided by X-ray diffraction data and phase equilibrium calculations, the model was based on the observation that, under water-splitting conditions, iron aluminates exist as a solid solution composed primarily of hercynite and magnetite spinels, the latter of which mediates oxygen exchange via cation—not oxygen—vacancies. An open-system thermodynamic analysis further indicated that, unlike pure magnetite, iron aluminate-based spinel solid solutions are capable of splitting water isothermally, a consequence of the change in Gibbs free energy due to mixing. Notably, these materials possess exceptional capacities for the isothermal production of hydrogen and, as a result, remain viable even under high conversion conditions. For example, for water splitting with a steam-hydrogen ratio as low as 500:1, the iron aluminate Fe33Al67 is still capable of producing over 200 μmol g⁻¹ of hydrogen at 1400° C., exceeding the predicted capacities of ceria and two attractive perovskite candidates following a 400° C. (or less) temperature swing. The demonstration of improved performance without requiring excess oxidant and or wide temperature swings represents a leap towards sustainable hydrogen production at scale using only renewable energy sources.

The example embodiments of the disclosure described above do not limit the scope of the invention, since these embodiments are merely examples of the embodiments of the invention. Any equivalent embodiments are intended to be within the scope of this invention. Indeed, various modifications of the disclosure, in addition to the embodiments shown and described herein, such as alternative useful combinations of the elements described, may become apparent to those skilled in the art from the description. Such modifications and embodiments are also intended to fall within the scope of the appended claims.

1. A method of splitting one or more of water and carbon dioxide, the method comprising:
providing a first material within a first reactor of a reactor system, the first material comprising two or more spinel phases in a solid solution, the solid solution comprising oxygen, aluminum, and one or more transition metals; and
providing one or more of H₂O and CO₂ to the reactor;
wherein a temperature within the first reactor is greater than 800° C.; and
wherein a partial pressure of oxygen within the first reactor is greater than 10⁻⁷ bar.

2. The method of claim 1, further comprising:
providing a second material within a second reactor of the reactor system, the second material comprising the same chemical formula as the first material; and
providing N₂ to the second reactor;
wherein a temperature within the second reactor is greater than 800° C.; and
wherein a partial pressure of oxygen within the second reactor is greater than 10⁻⁷ bar.

3. The method of claim 2, wherein one or more of the temperature within the first reactor and the temperature within the second reactor is between 800° C. and 1500° C.

4. The method of claim 2, wherein one or more of the partial pressure of oxygen within the first reactor and the partial pressure of oxygen within the second reactor is between 10⁻⁷ bar and 10-¹ bar.

5. The method of claim 2, wherein the first material and the second material each comprise (M_{ζ}Al_{1-ζ})_{3-δ}O₄, where ζ is greater than ⅓, and wherein M is one or more transition metals.

6. The method of claim 5, wherein ζ is greater than ⅓ and less than 1.

7. The method of claim 5, wherein M is selected from one or more of Fe, Co, Ti, Mn, Mg, Zn, Ni, and Cr.

8. The method of claim 5, wherein one or more of the first material and the second material comprises cation defects (δ), which enable the removal of oxygen and splitting of the one or more of the water and the carbon dioxide.

9. The method of claim 1, wherein the method comprises a two-step reduction-oxidation process.

10. The method of claim 9, wherein the two-step reduction-oxidation process is substantially isothermal.

11. The method of claim 2, wherein for water, the method is capable of producing hydrogen in atmospheres that contain existing hydrogen, such that the partial pressure of oxygen within the second reactor is greater than that described by a 7:1 H₂O:H₂ ratio.

12. The method of claim 2, wherein for CO2, the method is capable of producing carbon monoxide in atmospheres that contain existing carbon monoxide, such that the partial pressure of oxygen within the second reactor is greater than that described by a 2:1 CO₂:CO ratio.

13. The method of claim 2, wherein the partial pressure of oxygen in the first reactor is greater than the partial pressure of oxygen in the second reactor.

14. The method of claim 2, wherein the partial pressure of oxygen in the second reactor is greater than the partial pressure of oxygen in the first reactor.

15. The method of claim 1, wherein the method is capable of producing hydrogen and/or carbon monoxide at greater than 500 μmol per g of material per cycle.

16. A reactor system comprising:
a first reactor;
a first material within the first reactor, the first material comprising two or more spinel phases in a solid solution, the solid solution comprising oxygen, aluminum, and one or more transition metals;
one or more of a H₂O source and a CO₂ source fluidly coupled to the first reactor; and
a controller configured to:
control a temperature within the first reactor to greater than 800° C.; and
control a partial pressure of oxygen within the first reactor to greater than 10⁻⁷ bar.

17. The reactor system of claim 16, further comprising a second reactor comprising second material having the same chemical formula as the first material, wherein:
the controller is further configured to:
control a temperature within the second reactor to greater than 800° C.; and
control a partial pressure of oxygen within the second reactor to greater than 10⁷ bar.

18. The reactor system of claim 17, wherein the first reactor and the second reactor operate substantially isothermally.

19. The reactor system of claim 17, further comprising a nitrogen source coupled to the first reactor and the second reactor.
